(19) United States
(12) Patent Application Publication
(10) Pub. No.: US 2005/0012051 A1
(43) Pub. Date: Jan. 20, 2005

(54) Electron irradiation system

(76) Inventors: Gerhard Huebner, Panitzsch (DE); Manfred Zeising, Halle/Saale (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/694,440

(22) Filed: Oct. 28, 2003

(30) Foreign Application Priority Data
Oct. 28, 2002 (DE) 102 50 988.3

(51) Int. Cl. B29C 35/08

(52) U.S. Cl. 250/492.3; 264/488; 425/174.4

(57) ABSTRACT

Device for irradiation of at least one article/product by means of beams, especially by means of high-energy electron beams which can be produced in an irradiation system, the beams emerging from the electron accelerator in a radiation area, comprises at least one scanner means (54) which defines the radiation area (56), the radiation area (56) being formed spaced apart from the scanner means (54) in at least one plane (Eₙ) in which there is at least one transport means (TEₙ), and by means of which at least one bar-shaped/pipe-shaped article (Gᵣ) and/or other articles (Gₙ) can be moved into the irradiation position.

The invention relates to a device with the features which are named in the preamble of claim 1 and a process with the features named in the preamble of claim 46.

Electron irradiation systems of the generic type are already known. European patent EP 0 165 118 describes a system for polymerization/crosslinking of articles, mainly for treatment of elongated, rotationally-symmetrical parts, such as pipes, for example. The document describes this system for polymerization/crosslinking, the means for producing an electron beam, means for guiding the electron beam to the part which is to be worked, a target which can produce x-radiation under the action of the electron beam, means for arranging the target in the path of the electrons or outside it in order to irradiate the part with x-radiation or electron radiation, and means for executing the relative motion between the irradiating beam and the part, so that the latter is subjected to the action of one of the radiations in whole or in part. The pertinent relative motion consists of displacement of the part or the article along its axis which is horizontal and perpendicular to the axis of the radiating beam, combined with rotation of the part or the article around its axis. The content of the document is furthermore the description of two modes of action. On the one hand, the part is arranged such that it can be moved nearer the target or can be moved away from it, or on the other hand the axis of the part is held stationary and the target is moved in the direction of the article.

Document EP 0 715 936 describes one development of the irradiation device of European patent EP 0 165 118 by its improving the device in order to make it suitable for treatment especially of rotationally symmetrical parts with large dimensions and with segments of composite materials which are located in a very large range of distances relative to the axis of the part. For this purpose the device comprises an electron generator which is located in a shielded space and which comprises a linear accelerator which is provided with a horn with an irradiation window and with means for using the accelerator. A target for converting the electron beam into x-radiation which is retractably mounted in this way and which is inserted into the exit beam of the horn or not, and an irradiation cell which contains the structure (article) to be treated, and means for carrying and presenting the structure relative to the electron beam or the x-radiation are furthermore included in the system as claimed in the invention which is characterized in that the totality of the accelerator, horn, target and at least one part of the means for use is located on a platform which can move in the shielded space in the direction of the irradiation cell and according to a horizontal axis which is located parallel to the axis of the beam which has been produced by the accelerator. The movable equipment which has been formed in this way is provided with a radiation protection shield on its face which is pointed against the irradiation cell. The radiation protection shield can be moved in a passage which is made in a bulkhead between the irradiation cell and the shielded space, the edge of the radiation protection shield being matched to the cross section of the passage such that between the edge and the passage only play which is as small as possible remains.

The disadvantage in the systems which are known from the prior art is that only one article/product at a time is irradiated in one axis to the irradiation window. Moreover the means for delivery and removal in the irradiation space is not suited for transporting especially large articles/products into the irradiation space. Furthermore the possibilities for re-adjusting the product at the instant of irradiation are limited.

It is therefore the object of this invention to devise a device for irradiation of articles/products, by means of which at least one article or one product can be optimally moved into a favorable irradiation position according to its geometrical shape, especially rotationally symmetrical parts with large dimensions and/or flexible pipes of great length and/or individual items with large dimensions and alternatively several articles/products can be irradiated moreover at the same time.

The object of the invention is furthermore to devise a process with which the article or the respective product, individually or jointly with other articles or products, is supplied to the device, irradiated and removed.

As claimed in the invention, this object is achieved by the features named in claims 1 and 46. Because there is at least one scanner means which defines the radiation area, the radiation area being formed spaced apart from the scanner means in at least one plane in which there is at least one transport means and by means of which at least one bar-shaped/pipe-shaped article and/or other articles can be moved in the irradiation position, the result is advantageously that at least one article or product can be optimally moved into the irradiation position according to its geometrical shape, especially rotationally symmetrical parts with large dimensions and/or other articles with large dimensions and can be irradiated at the same time in at least one plane or different planes.

As claimed in the invention, this object is achieved by a process by which at least one bar-shaped/pipe-shaped article and/or other articles are supplied to at least one plane, a radiation area is assigned to this at least one plane and at least one article/product is moved into the irradiation position and is irradiated.

In a preferred embodiment of the invention, it is provided that at least one radiation area is formed on at least one radiation exit window and in at least one plane spaced apart from the scanner means in the x-direction by a scan magnet and in the y-direction by a wobbulator. Preferably it is provided that at least one radiation area is set up in the spaced plane by the focussing magnet of the scanner means, deviating in the x-direction to the radiation exit window. In one preferred embodiment of the invention the scanner means is at least a first scan horn with a first radiation exit window and a second scan horn with a second radiation exit window. Here the first radiation exit window and the second radiation exit window jointly form one radiation area both on the radiation exit window itself and also in the spaced plane.

In a preferred embodiment of the invention at least one bar-shaped/pipe-shaped article can be moved parallel to the x-direction on one x-scan axis by means of a bar/pipe transport means into a second plane into the radiation area into the irradiation position. It is possible to bundle bar-shaped/pipe-shaped articles with smaller diameter in secondary walls, for example cardboard sleeves or thin-walled PE pipes, and to transport them bundled in this way. In a preferred manner the bar/pipe transport device comprises a second feed means, a second irradiation transport means and a second removal means. The second feed means for the bar-shaped/pipe-shaped article comprises an incoming storage, an incoming individual conveyor, a first lowering path and an insertion path up to a pre-zone. The second irradiation transport means for the bar-shaped/pipe-shaped article is made as a bar irradiation section. The second removal means for the bar-shaped/pipe-shaped article comprises an alternating path, a second lowering path, a rollback path, a lifting path, an outgoing individual conveyor and an outgoing storage.

The bar irradiation section extends between a pre-zone and a post-zone with an irradiation space which lies in between. The bar irradiation section comprises at least one bar transport station. The bar transport station is located preferably parallel to the x-scan axis of at least one scan horn. The bar transport station has at least one column mechanism and at least one holding arm. In the preferred configuration in the bar transport station there are a rotation device, a translation device, a vertical adjustment device and a horizontal adjustment device. The rotation device, the translation device and the vertical adjustment device are preferably made by means of allround rollers.

In another preferred configuration of the invention at least one flexible pipe can be moved parallel to the x-direction on the x-scan axis or perpendicular to the x-direction in the y-scan axis by means of a pipe transport means into the first plane into the irradiation position. The bar/pipe transport means for a flexible pipe comprises at least a first feed means, at least a first irradiation transport means in the first plane and at least a first removal means. The first feed means and the first removal means comprise preferably a first and a second winding assembly. The first irradiation means comprises guide rollers and deflection rollers in the area of the first plane.

It is furthermore preferable that at least one individual item can be moved perpendicular to the x-direction in the y-scan axis by means of the individual item transport means into a third plane into the irradiation position. The individual item transport means for an individual item comprises at least a third feed means, at least a third irradiation transport means in the third plane and at least a third removal means. At least one third feed means, at least one third irradiation transport means and at least one third removal means are preferably conveyor means as a combination of chain conveyors and roller conveyors.

In a preferred embodiment of the invention each transport means for bar-shaped/pipe-shaped articles, for flexible pipes and individual items are assigned a labyrinth.

In a preferred version of the invention the process for irradiation of at least one bar-shaped/pipe-shaped article is carried out in a second labyrinth. It is preferable that the bar-shaped/pipe-shaped article is stored in the incoming storage and separated by means of an incoming individual conveyor and lowered by means of a first lowering path into a second plane and transported by means of an insertion path into a pre-zone and transported by the irradiation transport means from the pre-zone along the x-scan axis parallel to the x-direction through the radiation area into the post-zone and is accepted from the post-zone from an alternating path and transported to a second lowering path and lowered by means of the second lowering path and by means of a rollback path rolled to a lifting path and lifted by means of the lifting path and is transported by the outgoing individual conveyor to the outgoing storage and is stored in the outgoing storage.

The process as claimed in the invention moreover makes it possible for at least one bar-shaped/pipe-shaped article to be transported by means of the irradiation transport means from the pre-zone along the x-scan axis parallel to the x-direction-into the post-zone and within the irradiation transport means to be rotated at the same time by means of a rotation device around its own axis and/or to be re-adjusted vertically by means of a vertical adjustment device within a first and the second plane and/or to be re-adjusted horizontally by means of a horizontal adjustment device out of the x-scan axis within the first or second plane.

As claimed in the invention the process is furthermore carried out by at least one flexible pipe being unwound through a first labyrinth by means of a first winding assembly and being transported from a first irradiation transport means parallel to the x-direction on the x-scan axis or perpendicular to the x-direction in the y-scan axis through the radiation area by means of deflection and guide rollers and being wound up by means of a second winding assembly.

As claimed in the invention an individual item is transported through a third labyrinth by means of at least a first conveyor means and is transported from the third irradiation transport means perpendicular to the x-direction on the y-scan axis by means of at least the second conveyor means through the radiation area and is removed by means of at least the third conveyor means. In the preferred embodiment the individual item is turned on the first or third conveyor means during feed and removal by means of a turning station.

In another preferred configuration of the invention at the same time the flexible pipe and the bar-shaped/pipe-shaped articles are irradiated in the first and second plane in the radiation area into its irradiation position. Furthermore it is possible to irradiate at the same time the flexible pipe and the individual item in the first and the second plane in the radiation area in the respective irradiation position.

The device as claimed in the invention and the pertinent process offer the following advantages.

The transport means for bar-shaped/pipe-shaped articles, flexible pipes and individual items are located in one plane at a time—overall therefore at least three planes. Depending on the article/product, irradiation is possible in the lengthwise direction parallel to the x-axis or in the y-direction perpendicular to the x-axis of at least one scan horn.

It is of special importance and is especially advantageous that two articles/products can be irradiated in parallel.

Furthermore, by making the scanner means into a first and a second scan horn with different energies without mechanical modification, irradiation of the articles/products in two energy ranges is possible. The device is made for this purpose such that in the three planes the first or the second scan horn with its pertinent exit window and the pertinent radiation area can always be chosen for irradiation and thus is available for all products/ articles.

Advantageously, in this way a possible multivalent application of the electron irradiation system arises for an individual item, pipes, bars, flexible pipes and cables without the need for modifications.

Other technological means include in a preferred manner other systems for quality assurance, for logistics, for facility supply (compressed air, electrical and automation systems, cooling, ventilation, exhaust, etc.) and technological means for personnel and plant safety.

The entire system is controlled preferably with a memory-programmable control.

Other preferably embodiments of the invention result from the other features which are named in the dependent claims.

The invention is detailed below in one embodiment using the pertinent drawings:

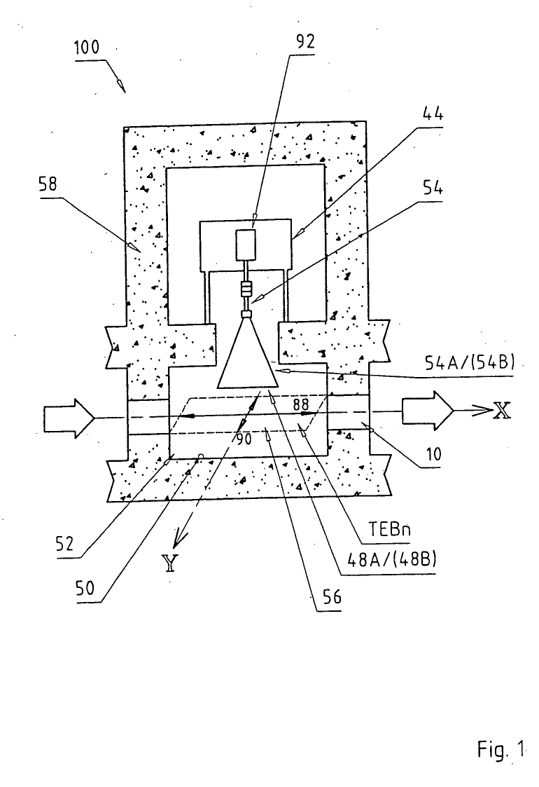

FIG. 1 shows the schematic structure of an electron irradiation system;

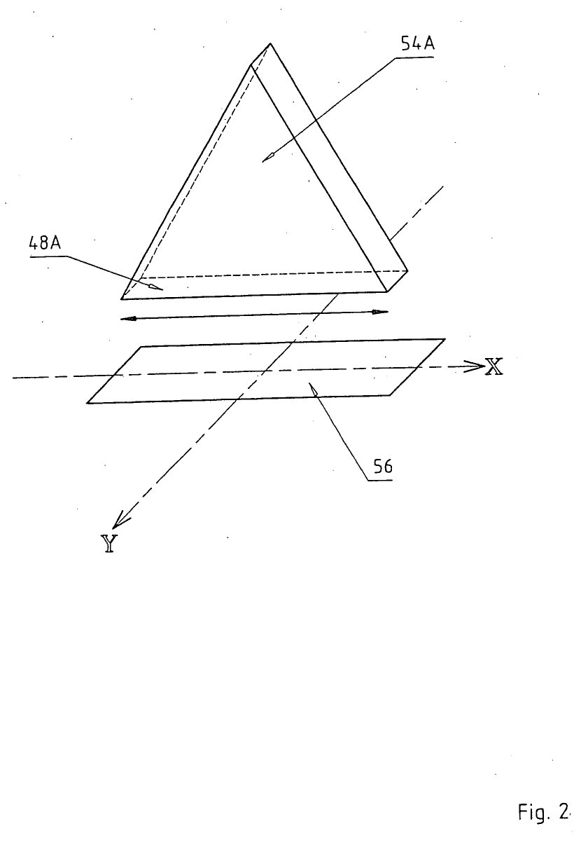

FIG. 2 shows a scan horn, its radiation area and directions of movement for the articles/products in the radiation area;

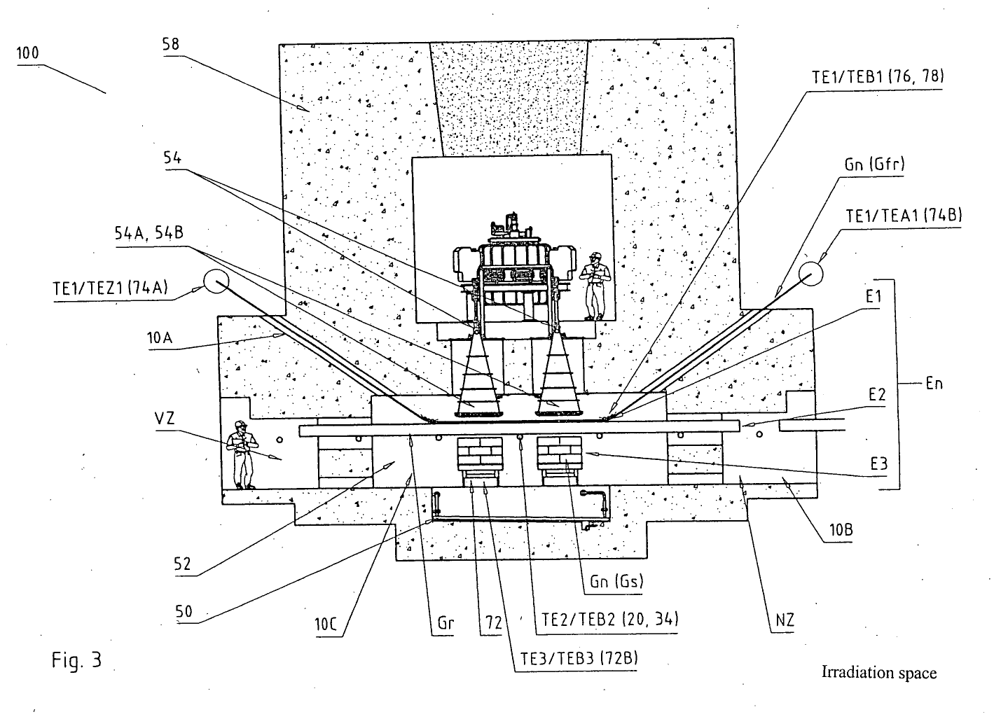

FIG. 3 shows a schematically detailed representation of the structure of the electron irradiation system;

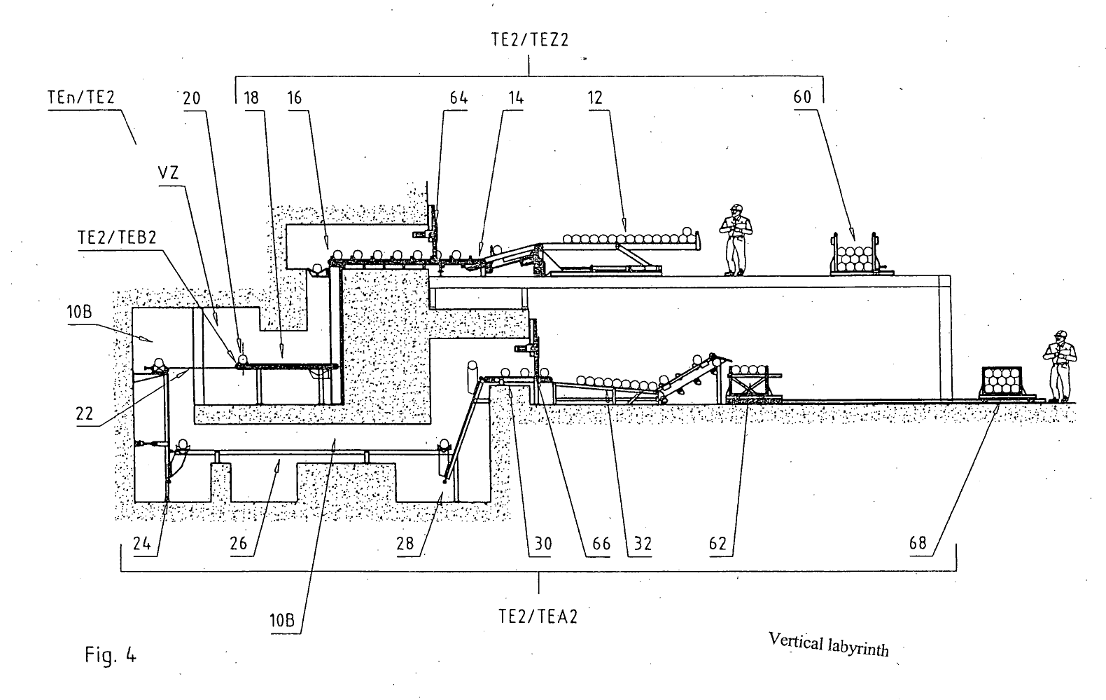

FIG. 4 shows a vertical labyrinth for a bar-shaped/pipe-shaped article;

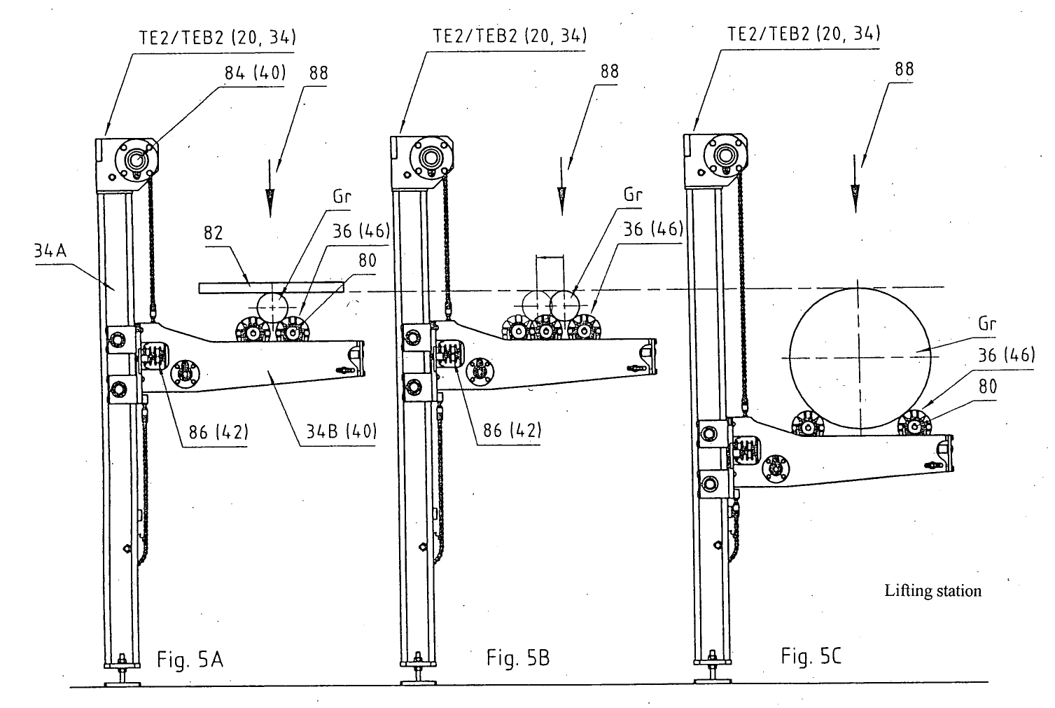

FIG. 5A shows the bar transport station of a bar irradiation section with bar-shaped/pipe-shaped articles in the x-scan axis;

FIG. 5B shows the bar transport station of a bar irradiation section with vertical displacement of the bar-shaped/pipe-shaped articles out of the x-scan axis;

FIG. 5C shows the bar transport station of a bar irradiation section of the bar-shaped/pipe-shaped article on the x-scan axis with a large diameter;

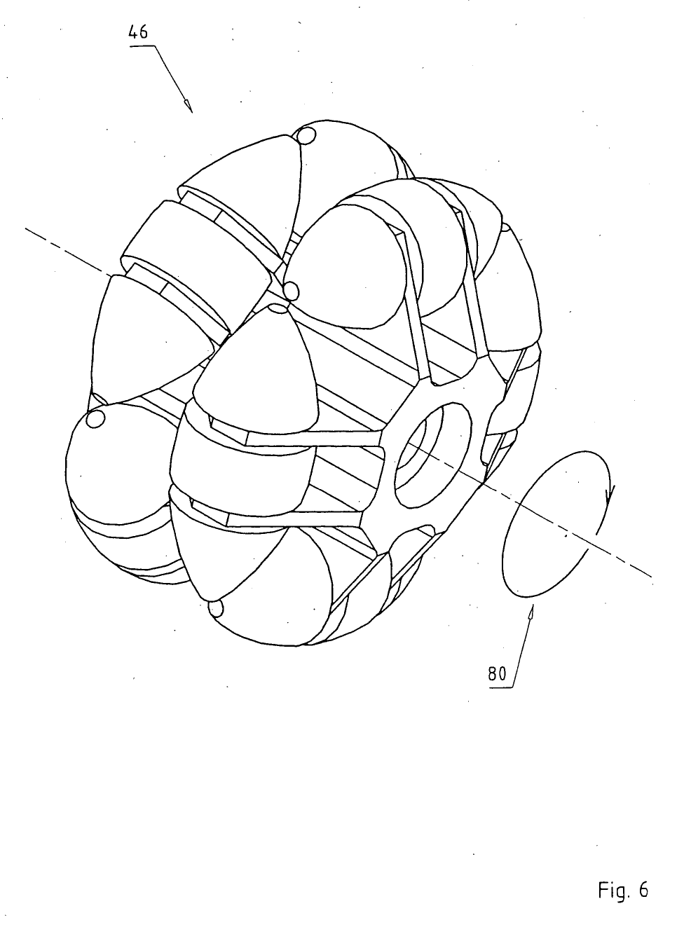

FIG. 6 shows an allround roller;

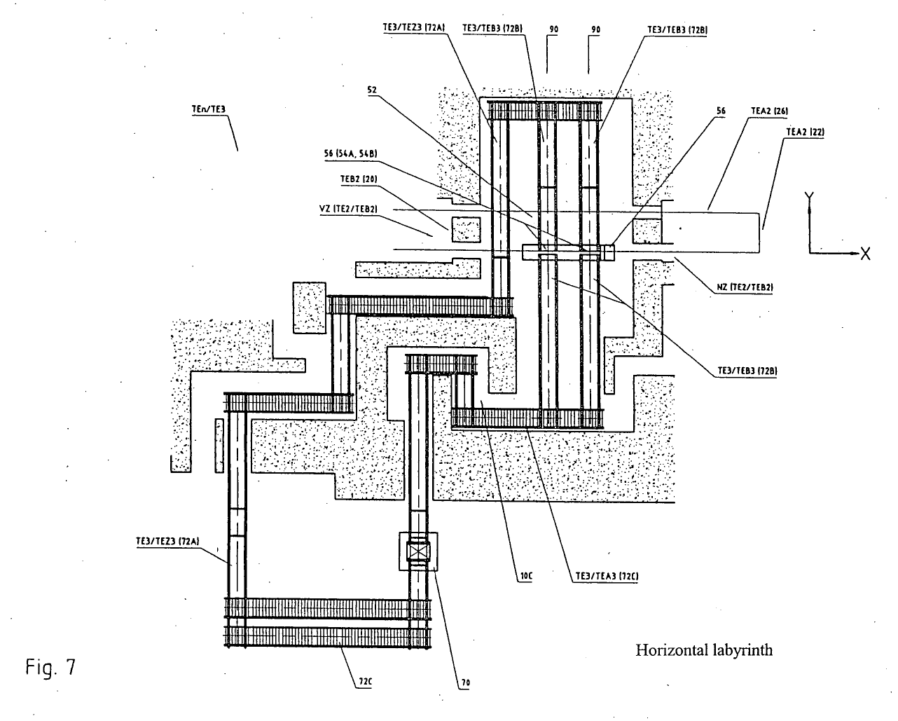

FIG. 7 shows a horizontal labyrinth for an individual item and

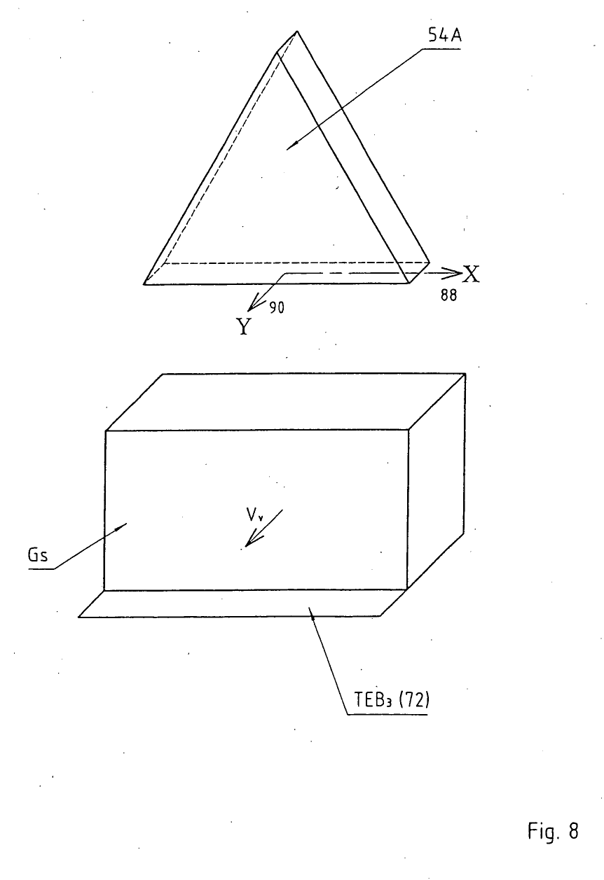

FIG. 8 shows a schematic view of an individual item underneath the scanner means.

An electron irradiation system has the following applications: for example, radiation crosslinking of polymers, radiochemical decomposition of polymers, modification of solids, germ number reduction of selected products and sterilization of medical products and packaging materials. Electron irradiation systems with these applications have a fundamentally similar structure. They consist of an electron accelerator of varied design, of one or more material feed and removal systems, shielding systems for protection against radiation and of primary and secondary supply and safety systems. The basic structure of the irradiation system is shown in FIG. 1.

FIG. 1 shows in one preferred embodiment the electron irradiation system 100 in which the electron accelerator 92 is a particle accelerator, preferably of the rhodotron type. The acceleration sections of the electron accelerator 92 are located in a coaxially shaped resonator in which a vacuum of 10⁻⁶ torr prevails. The HF voltage is produced by a multistage HF generator and is supplied to the power tube on the top part of the resonator via a high voltage cable. The HF field is coupled with a wattage of preferably roughly 160 kW.

An electron gun delivers an average current of 10 mA which is injected into the resonator with low energy, preferably 50 keV. The applied HF field with a frequency of preferably 107.5 MHz accelerates the electrons in 20 stages to a maximum energy of 10 MeV. After two acceleration stages at a time deflection by 198° takes place. This results in a maximum possible radiation power of 80 kW at an energy of 10 MeV or of a maximum 75 kW at an energy of 3 MeV.

The electron beam can be routed out of the resonator with two energies. For each of the two electron energies there is a separate beam guidance system in which one preferably 270° deflection magnet moves the electron beam into the vertical direction. To form a radiation area 56 a scanner means 54 is used, a wobbulator providing for widening the radiation area 56 to preferably 60 mm in the y-direction y, and a scan magnet providing lengthwise widening in the x-direction x of the radiation area 56 to preferably 1200 mm on the first radiation exit window 48A. On the radiation exit window 48 of the scanner means 54 or of the first scan horn 54A an additional focussing magnet provides for the possibility of setting different scan widths at the location of the product which is to be irradiated, by which the radiation area 56 is changed in the x-direction x, the scan width on the radiation exit window 48 being preserved with preferably 1200 mm. One special operating mode of the focussing magnets is the parallel beam. The radiation exit window 48 of titanium foil (thickness roughly 50 microns) is air-cooled. The electron beam enters the atmosphere and can be used there for product irradiation. It can thus be expected that not all electrons hit the product which is to be irradiated and they move further in the direction of the ground. For this reason there is a water-cooled radiation trap 50 in the irradiation space 52 for beam neutralization underneath the top edge of the floor. The scanner means 54 can be implemented by means of a first scan horn 54A and a second scan horn 54B, which is detailed in FIG. 3. In this case, on the first scan horn 54A the first radiation exit window 48A and a second radiation exit window 48B are made and jointly they can form the radiation area 56. On the other hand, the first scan horn 54A can be provided with a radiant power energy of 10 MeV and the second scan horn 54B with a radiant power energy of 3 MeV.

FIG. 1 furthermore shows that underneath the first scan horn 54A, 54B in the radiation area 56 an area for article/product guidance in the x-direction x on the x-scan axis 88 and in the y-direction y on the y-scan axis 90 can be used. In the radiation area 56 in different planes the irradiation transport means TEBₙ are made, by means of which the articles/products are moved into the irradiation position.

The entire electron irradiation system 100 has shielding 58 and is controlled by a control 44.

FIG. 2 shows the first scan horn 54A with the radiation exit window 48A and the radiation area 56 and the possible transport directions of the articles in the x-direction x parallel to the first scan horn 54A and in the y-direction y perpendicular to the first scan horn 54A.

FIG. 3 shows the electron irradiation system 100 in a detailed schematic view. FIG. 3 shows the shielding 58, the first scan horn 54A and the second scan horn 54B underneath the scanner means 54. Moreover the irradiation space 52 and the radiation trap 50 are visible. FIG. 3 shows by way of suggestion the articles in their irradiation position in the plane Eₙ. In the first plane E₁ an article G_{fr} is shown, a flexible pipe. In the second plane E₂ a bar-shaped/pipe-shaped article Gᵣ is shown. Smaller pipes or bars with a diameter less than 60 mm can be bundled into cardboard sleeves or thin-walled PE pipes and can be delivered for irradiation in this way. In this way sagging of the individual thin pipes or bars which is disadvantageous for the transport process is avoided. In the third plane E₃ FIG. 1 shows an article as an individual item G_{B} which can be moved under the first scan horn 54A or the second scan horn 54B into the irradiation position.

The flexible pipe G_{fr} includes a first labyrinth 10A and a pipe transport means TE₁ which is made from a first feed means TEZ₁, a first irradiation transport means TEB₁, and a first removal means TEA₁. The first feed means TEZ₁ is made as a first winding assembly 74A and the first removal means TEA₁ is made as a second winding assembly 74B. The winding assemblies 74 are used to unwind or take-up the flexible pipes G_{fr}, while in the irradiation space 52 there are guide rollers 76 and deflection rollers 87 as the first irradiation transport means TEB₁. The pipe transport means TE₁ fundamentally makes it possible to move the flexible pipe G_{fr} parallel to the x-direction x on the x-scan axis 88 into the first plane E₁ into the irradiation position. Neither FIG. 3 nor the other figures show the possibility that the flexible pipe G_{fr} can likewise be moved perpendicular to the x-direction x into the y-scan axis 90 by means of the pipe transport means TE₁ into the first plane E₁ into the irradiation position.

FIG. 3 furthermore shows a bar/pipe transport means TE₂—however in FIG. 3 only a second irradiation transport means TEB₁ in a second labyrinth 10B, the so-called vertical labyrinth. The second irradiation transport means TEB₂ consists in detail of a bar irradiation section 20 and the bar irradiation section 20 in turn consists of several bar transport stations 34 which are detailed in FIGS. 5A to 5C. The second labyrinth 10B includes a pre-zone VZ and a post-zone NZ which separates the irradiation space 52 from the remaining vertical labyrinth 103, from the direction of the pre-zone VZ a second feed means TEZ₂ for the bar-shaped/pipe-shaped article Gᵣ being formed (not visible in FIG. 3) and in the post-zone NZ a second removal means TA₂ for removal of the bar-shaped/pipe-shaped article Gᵣ (not visible in FIG. 3) beginning. In the third plane El there is a third transport means, an individual item transport means TE₃. FIG. 3 shows part of the individual item transport means TE₃ in which the individual item G_{B} is irradiated in the third plane E₃ on the third conveyor means 72C. The individual item transport means TE₃ is further described in FIG. 7. The individual item transport means TE₃ is guided through a third labyrinth 10C which is likewise detailed in FIG. 7.

FIG. 4 shows the bar/pipe transport means. TE₂ in the second labyrinth 10B, the vertical labyrinth. The second bar/pipe transport means TE₂ consists of the second feed means TEZ₂ of the second irradiation transport means TEB₂ (not visible in FIG. 4) and a second removal means TA₂.

The device jointly with the pertinent process for irradiation of bar-shaped/pipe-shaped articles Gᵣ is described below. According to the object of the process as claimed in the invention and the device as claimed in the invention the goal is to guide the bar-shaped/pipe-shaped articles Gᵣ through the second labyrinth 10B into the second plane. E₂ into the radiation area 56.

The bar-shaped/pipe-shaped article Gᵣ is delivered to unpacking 60 in a first station. Then the article Gᵣ is stored in the incoming storage 12 and separated by means of an incoming individual conveyor 14, in the area of the incoming individual conveyor 14 a hermetic incoming gate 64 being located. After separation, by means of a first lowering path 16 the article Gᵣ is lowered into the second plane E₂ and by means of an insertion path 18 into the pre-zone VZ transport within the second feed means TEZ₂ is ended.

Then, by means of the second irradiation transport means TEB₂ from the pre-zone VZ along the x-scan axis 88 parallel to the x-direction x in the radiation area 56 the article Gᵣ is irradiated in its irradiation position and is transported on to the post-zone NZ. This area is not shown in FIG. 4, for which reason it is detailed in other figures.

After transport of the article Gᵣ into the post-zone NZ, take-over occurs from the alternating path 24 out of the post-zone NZ to a second lowering path 24 which lowers the article Gᵣ once again, after which by means of a rollback path 26 the article Gᵣ is rolled to a lifting path 28 and is raised by means of the lifting path 28 and transported from the outgoing individual conveyor 30 to the outgoing storage 32 and is stored in the outgoing storage 32. The article Gᵣ in the area of the outgoing individual conveyor 30 passes an outgoing gate 66 which blocks off the second labyrinth 10B from the surroundings. Then packaging 62 and removal 68 of the bar-shaped/pipe-shaped articles Gᵣ take place.

FIG. 5A shows the bar transport station 34 as part of the bar irradiation section 20 within the second irradiation transport means TEB₂. The bar transport stations 34 are located parallel to the x-scan axis 88 from the pre-zone VZ via the irradiation space 52 to the post-zone NZ. Preferably in the pre-zone VZ there are nine bar transport stations 34, in the irradiation space 52 eleven bar transport stations 34 and in the post-zone NZ in turn nine bar transport stations 34. FIG. 5A shows that the bar transport stations 34 have a column mechanism 34a and a holding arm 34B. Moreover on the holding arm 34B there are elements which are used as a rotation device 36 or as a translation device 38. This element is preferably an allround roller 46. The article Gᵣ, here the bar-shaped/pipe-shaped article Gᵣ, is located on the x-scan axis 88 and is located between two allround rollers 46. The allround rollers 46 have a first drive 80 by means of which on the axis of the allround roller 46 the bar-shaped/pipe-shaped article Gᵣ is shifted into rotational motion. A second drive 82 with the suggested driver chain causes translational motion of the bar-shaped/pipe-shaped article Gᵣ on the allround roller 46. For vertical re-adjustment a vertical adjustment device 40 is used which enables vertical re-adjustment of the holding arm 34B by means of a third drive 84 and thus adjustability in the area of the first and second plane E₁, E₂ of the bar-shaped/pipe-shaped article Gᵣ. The possibility of horizontal re-adjustment by means of a horizontal adjustment device 42 both in FIG. 5A and also in FIG. 5B by means of a fourth drive 86 is shown. The bar-shaped/pipe-shaped article Gᵣ can be re-adjusted by this horizontal adjustment device 42 for optimum dose distribution in the pipe, preferably in the range from 0 to 300 mm out of its x-scan axis 88.

FIG. 5C shows that even bar-shaped/pipe-shaped articles Gᵣ with large diameters can be guided on the x-scan axis 88 by horizontal displacement of the allround roller 46. According to FIG. 5B of course horizontal readjustment of the article Gᵣ leading out of the x-scan axis is possible, then the center line of the article Gᵣ being spaced away from the x-scan axis 88. FIG. 5B and FIG. 5C do not show the driver chain for implementing the translational motion in the x-direction x with the pertinent second drive 82.

The process therefore enables the bar-shaped/pipe-shaped article Gᵣ to be transported by means of the second irradiation transport means TEB₂ from the pre-zone VZ along the x-scan axis 88 parallel to the x-direction x into the post-zone NZ and at the same time by means of the rotation device 36 to be rotated around its own axis and/or to be re-adjusted vertically by means of the vertical adjustment device 40 within the first and the second plane E₁, E₂ and/or to be re-adjusted horizontally out of the x-scan axis 88 within the first or second plane E₁ , E₂ by means of the horizontal adjustment device 42.

FIG. 6 shows the allround roller 46 with the first drive 80 on one axis of the allround roller 46, the first drive 80 only being suggested.

FIG. 7 shows the third labyrinth 10C—the so-called horizontal labyrinth. In the third labyrinth 10C the transport means TEₙ is shown in an execution of an individual item transport means TE₃. The individual item transport means TE₃ consists of a third feed means TEZ₃ and a third removal means TA₃. The third feed means TEZ₃ comprises a first conveyor means 72A and the third removal means TEA₃ comprises the third conveyor means 72C. The third irradiation transport means TEB₃ in the radiation area 56 comprises two second conveyor means 72B and 72B′. A second conveyor means 72B is located under the first scan horn 54A and the second conveyor means 72B′ is located under the second scan horn 54B. FIG. 7 shows as an overhead view the irradiation space 52 and the radiation area 56 which is made by the scan horns 54A, 54B. FIG. 7 illustrates that the individual items are transported by the first conveyor means 72A to the radiation space 52 and transported from the third irradiation transport means TEB₃ perpendicular to the x-direction x on the y-scan axis 90 by means of the second conveyor means 72B, 72B′ through the radiation area 56 and are removed by the third conveyor means 72C. The individual item Gₛ can be turned on the first or third conveyor means 72A, 72C by means of a turning station 70.

FIG. 7 illustrates that in the radiation area 56 the third irradiation transport means TEB₃ for the individual item Gₛ is crossed by the second irradiation transport means TEB₂ for the bar-shaped/pipe-shaped articles Gᵣ. The pre-zone VZ is shown which leads parallel to the x-axis as far as the post-zone NZ through the irradiation space 52. This crossing of the second and third irradiation transport means TEB₂, TEB₃ is only possible by the arrangement in the pertinent second and third planes E₂, E₃. Not shown in FIG. 7, in the radiation area 56 above the second and third irradiation transport means TEB₂, TEB₃ there is the first irradiation transport means TEB₁ for the flexible pipe which likewise runs in the x-direction x on the x-scan axis 88. As claimed in the invention, at the same time a flexible pipe G_{fr} and bar-shaped/pipe-shaped articles Gᵣ in the first and second plane E₁, E₂ in the radiation area 56 can be irradiated in the electron irradiation system 100. Furthermore, at the same time with the flexible pipe G_{fr} an individual item Gₛ can be irradiated in the first and third plane E₁, E₃ in the radiation area 56 in the irradiation position.

FIG. 8 finally shows again the scan horn 54 and an individual item which is located under the scan horn 54 and which is transported in the y-direction y along the y-scan axis 90 by means of the third irradiation transport means TEB₃, preferably the second conveyor means 72B.

Preferably the following articles/products with the following dimensions can be irradiated:
bar-shaped/tube-shaped articles Gᵣ with a diameter of preferably 63 mm to 500 mm and a length from 5 m to 12 m and
flexible pipes G_{fr} with a diameter of preferably 14 mm to 22 mm and a length of for example 10,000 m and
flexible pipes G_{fr} with a diameter of preferably 32 mm to 63 mm and a length of for example 2,000 m and individual items Gₛ, for example cardboard articles with dimensions of for example length/width/height 1200 mm×1200 mm×800 mm.

By means of the electron irradiation system 100 for the indicated articles Gᵣ, G_{fr}, Gₛ optimum dose values can be realized as necessary in the range from 2 kGy≦D≦200 kGy. The maximum dose rate is roughly 1.4×10⁸ Gy/h. The average product dose rate is 10⁻² kGy/s≦dD/dt≦40 kGy/s.

Dose uniformity in different directions of the product is guaranteed as follows: in the x-direction x by the radiation distribution±5%, in the y-direction y by the constancy of the transport speed.

The distance of the bar-shaped/tube-shaped articles Gᵣ is set to be constant from their surface to the radiation exit for all diameters of the bar-shaped/pipe-shaped articles Gᵣ.

### Reference Number List

100 electron irradiation system
10 labyrinth
10A first labyrinth
10B second labyrinth (vertical labyrinth)
10C third labyrinth (horizontal labyrinth)
12 incoming storage
14 individual conveyor (incoming)
16 first lowering path
18 insert path
20 bar irradiation section
22 alternating path
24 second lowering path
26 rollback path
28 lifting path
30 individual conveyor (outgoing)
32 outgoing storage
34 bar transport station
34A column mechanism
34B holding arm
36 rotation device
38 translation device
40 vertical adjustment device
42 horizontal adjustment device
44 control
46 allround roller
48 radiation exit window
48A first radiation exit window
48B second radiation exit window
50 radiation trap
52 irradiation space
54 scanner means
54A first scan horn
54B second scan horn
56 radiation area
58 shielding
60 unpacking
62 packaging
64 incoming gate
66 outgoing gate
68 removal
70 turning station
72 conveyor means
72A first conveyor means
72B/72B′ second conveyor means
72C third conveyor means
74 winding assembly
74A first winding assembly
74B second winding assembly
76 guide roller
78 deflection roller
80 first drive (rotation)
82 second drive (translation)
84 third drive (vertical)
86 fourth drive (horizontal)
88 x-scan axis
90 y-scan axis
92 electron accelerator
x x-direction
y y-direction
VZ pre-zone
NV post-zone
TEₙ transport means
TE₁ pipe transport means (flexible pipes)
TEZ₁ first feed means
TEB₁ first irradiation transport means
TEA₁ first removal means
TE₂ bar/pipe transport means
TEZ₂ second feed means
TEB₂ second irradiation transport means
TEA₂ second removal means
TE₃ individual item transport means
TEZ₃ third feed means
TEB₃ third irradiation transport means
TEA₃ third removal means
Eₙ planes
E₁ first plane
E₂ second plane
E₃ third plane
Gₙ articles/products
Gᵣ bar-shaped/pipe-shaped article
Gₛ individual item
G_{fr} flexible pipe

1. Device for irradiation of at least one article/product by means of beams, especially by means of high-energy electron beams which can be produced in an irradiation system, the beams emerging from the electron accelerator in a radiation area, characterized by at least one scanner means (54) which defines the radiation area (56), the radiation area (56) being formed spaced apart from the scanner means (54) in at least one plane (Eₙ) in which there is at least one transport means (TEₙ), and by means of which at least one bar-shaped/pipe-shaped article (Gᵣ) and/or other articles (Gₙ) can be moved into the irradiation position.

2. Device as claimed in claim 1, wherein at least one radiation area (56) is formed on at least one radiation exit window (48) and in at least one plane (Eₙ) which is spaced apart from the scanner means (54) in the x-direction (x) by a scan magnet and in the y-direction (y) by a wobbulator.

3. Device as claimed in claim 1, wherein at least one radiation area (56) is set in the spaced planes (Eₙ) by the focussing magnet of the scanner means (54), deviating in the x-direction (x) to the radiation exit window (48).

4. Device as claimed in claim 1, wherein the scanner means (54) comprises at least a first scan horn (54A) with a first radiation exit window (48A) and a second scan horn (54B) with a second radiation exit window (48B).

5. Device as claimed in claim 1, wherein at least one bar-shaped/pipe-shaped article (Gᵣ) can be moved parallel to the x-direction (x) on one x-scan axis (88) by means of a bar/pipe transport means (TE₂) into a second plane (E₂) into the radiation area (56) into the irradiation position.

6. Device as claimed in claim 1, wherein the bar/pipe transport device (TE₂) for the bar-shaped/pipe-shaped article (Gᵣ) comprises at least a second feed means (TEZ₂).

7. Device as claimed in claim 1, wherein the second feed means (TEZ₂) for the bar-shaped/pipe-shaped article (Gᵣ) comprises an incoming storage (12), an incoming individual conveyor (14), a first lowering path (16) and an insertion path (18) up to a pre-zone (VZ).

8. Device as claimed in claim 1, wherein the bar/pipe transport means (TE₂) for the bar-shaped/pipe-shaped article (Gᵣ) comprises at least a second irradiation transport means (TEB₂) in the second plane (E₂).

9. Device as claimed in claim 1, wherein the second irradiation transport means (TE₂) for the bar-shaped/pipe-shaped article (Gᵣ) is a bar irradiation section (10).

10. Device as claimed in claim 1, wherein the bar/pipe transport means (TE₂) for the bar-shaped/pipe-shaped article (Gᵣ) comprises at least a second removal means (TEA₂) from the post-zone (NZ) of the irradiation space (52).

11. Device as claimed in claim 1, wherein the second removal means (TEA₂) for the bar-shaped/pipe-shaped article (Gᵣ) comprises an alternating path (22), a second lowering path (24), a rollback path (26), a lifting path (28), an outgoing individual conveyor (30) and an outgoing storage (32).

12. Device as claimed in claim 1, wherein the bar irradiation section (20) extends between a pre-zone (VZ) and a post-zone (NZ) and an irradiation space (52).

13. Device as claimed in claim 1, wherein the bar irradiation section (20) comprises at least one bar transport station (34).

14. Device as claimed in claim 1, wherein the bar transport station (34) is located parallel to the x-scan axis (88) of at least one scan horn (54, 56).

15. Device as claimed in claim 1, wherein the bar transport station (34) has at least one column mechanism (34A) and at least one holding arm (34B).

16. Device as claimed in claim 1, wherein the bar transport station (34) has a rotation device (36).

17. Device as claimed in claim 1, wherein the bar transport station (34) has a translation device (38).

18. Device as claimed in claim 1, wherein the bar transport station (34) has a vertical adjustment device (40).

19. Device as claimed in claim 1, wherein the bar transport station (34) has a horizontal adjustment device (42).

20. Device as claimed in claim 1, wherein the rotation device (36), the translation device (38) and the vertical adjustment device (40) are made by means of at least one allround roller (46).

21. Device as claimed in claim 1, wherein the rotation device (36) has a first drive (80) on the allround roller (46).

22. Device as claimed in claim 1, wherein the translation device (38) has a second drive (82) on a driver chain.

23. Device as claimed in claim 1, wherein the vertical adjustment device (40) has a third drive (84) on a chain in the column mechanism (34A).

24. Device as claimed in claim 1, wherein the horizontal adjustment device (42) has a fourth drive (84) on the holding arm (34B).

25. Device as claimed in claim 1, wherein at least one flexible pipe (G_{fr}) can be moved parallel to the x-direction (x) on the x-scan axis (88) or perpendicular to the x-direction (x) in the y-scan axis (90) by a pipe transport means (TE₁) into the first plane (E₁) into the irradiation position.

26. Device as claimed in claim 1, wherein the pipe transport means (TE₁) for a flexible pipe (G_{fr}) comprises at least one first feed means (TEZ₁).

27. Device as claimed in claim 1, wherein the pipe transport means (TE₁) for a flexible pipe (G_{fr}) comprises at least a first irradiation transport means (TEB₁) in the first plane (E₁).

28. Device as claimed in claim 1, wherein the pipe transport means (TE₁) for a flexible pipe (G_{fr}) comprises at least one first removal means (TEA₁)

29. Device as claimed in claim 1, wherein at least a first feed means (TEZ₁) and at least a first removal means (TEA₁) comprise a first winding assembly (74A) and a second winding assembly (74B).

30. Device as claimed in claim 1, wherein at least the first irradiation means (TEB₁) comprises guide rollers (76) and deflection rollers (78).

31. Device as claimed in claim 1, wherein at least one individual item (Gₛ) can be moved perpendicular to the x-direction (x) in the y-scan axis (90) by means of the individual item transport means (TE₃) into the third plane (E₃) into the irradiation position.

32. Device as claimed in claim 1, wherein the individual item transport means (TE₃) for an individual item (Gₛ) comprises at least a third feed means (TEZ₃).

33. Device as claimed in claim 1, wherein the individual item transport means (TE₃) for an individual item (Gₛ) comprises at least a third irradiation transport means (TEB₃) in the third plane (E₃).

34. Device as claimed in claim 1, wherein the individual item transport means (TE₃) for an individual item (Gₛ) comprises at least a third removal means (TEA₃).

35. Device as claimed in claim 1, wherein at least one third feed means (TEZ₃), at least one third irradiation transport means (TEB₃) and at least one third removal means (TEA₃) comprises a conveyor means (72A, 72B, 72C).

36. Device as claimed in claim 1, wherein at least one third feed means (TEZ₃) or at least one third removal means (TEA₃) comprises a turning station (70).

37. Device as claimed in claim 1, wherein each transport means (TE₁, TE₂, TE₃) forms one labyrinth (10A, 10B, 10C) at a time.

38. Device as claimed in claim 1, wherein at least one bar-shaped/pipe-shaped article (Gᵣ) is pipes or bars or the like.

39. Device as claimed in claim 1, wherein the pipes or bars or the like have a diameter from 10 mm to 500 mm.

40. Device as claimed in claim 1, wherein the pipes or bars or the like have a length from 5,000 mm to 12,000 mm.

41. Device as claimed in claim 1, wherein at least one flexible pipe (G_{fr}) is a flexible pipe, a cable or the like.

42. Device as claimed in claim 1, wherein the flexible pipes or the cable or the like have a diameter from 1 mm to 160 mm, preferably 14 mm to 63 mm.

43. Device as claimed in claim 1, wherein the flexible pipes or the cable or the like are drum-wound articles.

44. Device as claimed in claim 1, wherein at least one individual item (Gₛ) is a cardboard product or bunches or the like.

45. Device as claimed in claim 1, wherein the cardboard product or bunches or the like have a maximum length/width/height of 1200 mm 1200 mm/800 mm.

46. Device as claimed in claim 1, wherein the bar-shaped/pipe-shaped article (Gᵣ) has an auxiliary wall for holding several thin pipes or bars.

47. Process as claimed in claim 46, wherein the auxiliary wall is a cardboard sleeve or a thin-walled PE pipe.

48. Process for irradiating at least one article/product by means of beams, especially by means of high-energy electron beams which have been produced in an irradiation system, the beams emerging in a certain radiation area and at least one article/product being supplied to the radiation area, irradiated in the radiation area and being removed from the irradiation area, wherein at least one bar-shaped/pipe-shaped article (Gᵣ) and/or other articles (Gₙ) are supplied to at least one plane (Eₙ), the radiation area (56) is assigned to this at least one plane (Eₙ) and at least one article/product (Gᵣ/Gₙ) is moved into the irradiation position and is irradiated.

49. Process as claimed in claim 48, wherein at least one bar-shaped/pipe-shaped article (Gᵣ) through a second labyrinth (10B)
a) is stored in the incoming storage (12) and
b) separated by means of an incoming individual conveyor (14) and
c) lowered by means of a first lowering path (16) into a second plane (E₂) and
d) transported by means of an insertion path (18) into a pre-zone (VZ) and
e) transported by the second irradiation transport means (TEB₂) from the pre-zone (VZ) along the x-scan axis (88) parallel to the x-direction (x) through the radiation area (56) into the post-zone (NZ) and
f) is accepted from the post-zone (NZ) from an alternating path (22) and transported to a second lowering path (24) and
g) lowered by means of the second lowering path (24) and
h) by means of a rollback path (26) is rolled to a lifting path (28) and
i) lifted by means of the lifting path (28) and
j) is transported by the outgoing individual conveyor (30) to the outgoing storage (32) and
k) is stored in the outgoing storage (32).

50. Process as claimed in claim 49, wherein at least one bar-shaped/pipe-shaped article (Gᵣ) is transported by means of the second irradiation transport means (TEB₂) from the pre-zone (VZ) along the x-scan axis (88) parallel to the x-direction (x) into the post-zone (NZ) and
e1) is rotated at the same time by means of a rotation device (36) around its own axis and/or
e2) is re-adjusted vertically by means of a vertical adjustment device (40) within a first and the second plane (E₁, E₂) and/or
e3) is re-adjusted horizontally by means of a horizontal adjustment device (42) out of the x-scan axis (88) within the first or second plane (E₁, E₂).

51. Process as claimed in claim 48, wherein at least one flexible pipe (G_{fr}) through a first labyrinth (10A)
a) is unrolled by means of a first winding assembly (74A) and
b) is transported from a first irradiation transport means (TEB₁) parallel to the x-direction (x) on the x-scan axis (88) or perpendicular to the x-direction (x) in the y-scan axis (90) through the radiation area (56) by means of deflection and guide rollers (76,78) and
c) is wound up by means of a second winding assembly (74B).

52. Process as claimed in claim 48, wherein an individual item (Gₛ) is transported through a third labyrinth (10C)
a) by means of at least a first conveyor means (72A) and
b) is transported from a third irradiation transport means (TEB₃) perpendicular to the x-direction (x) on the y-scan axis (90) by means of at least the second conveyor means (72B/72B′) through the radiation area (56) and
c) is removed-by means of at least the third conveyor means (72c).

53. Process as claimed in claim 52, wherein at least one individual item (Gₛ) is supplied or removed by means of at least the first or third conveyor means (72A, 72C) and
c1) is turned by means of a turning station (70) on the first or third conveyor means (72A, 72C).

54. Process as claimed in claim 48, wherein at the same time flexible pipe (G_{fr}) and the bar-shaped/pipe-shaped articles (Gᵣ) are irradiated in the first and second plane (E₁, E₂) in the radiation area (56) in the irradiation position.

55. Process as claimed in claim 48, wherein at the same time flexible pipe (G_{fr}) and an individual item (Gₛ) are irradiated in the first and third plane (E₁, E₃) in the radiation area (56) in the irradiation position.

56. Process as claimed in claim 48, wherein several thin pipes or bars are introduced into the bar-shaped/pipe-shaped article and are supplied jointly to irradiation.
